(19) United States
(12) Patent Application Publication
(10) Pub. No.: US 2026/0234335 A1
(43) Pub. Date: Aug. 13, 2026

(54) PREPARATION OF AN ALKOXY- OR HYDROXY- TERMINATED POLY (PHENYMETHYL) SILOXANE

(71) Applicant: Dow Silicones Corporation, Midland, MI (US)

(72) Inventors: Peng-Fei Fu, Midland, MI (US); Yanhu Wei, Midland, MI (US); Matt Dowland, Midland, MI (US)

(21) Appl. No.: 19/471,047

(22) PCT Filed: Apr. 3, 2024
(86) PCT No.: PCT/US2024/022721

§ 371 Date: Sep. 30, 2025

Related U.S. Application Data
(60) Provisional application No. 63/460,160, filed on Apr. 18, 2023.

(51) Int. Cl. C08G 77/04; C08G 77/00; C08G 77/06; C08G 77/18

(52) U.S. Cl. CPC C08G 77/045; C08G 77/06; C08G 77/18; C08G 77/80

(57) ABSTRACT

The present invention relates to a method comprising the step of contacting a cyclic phenylmethylsiloxane with a chain transfer agent and a catalytic amount of a base under ring-opening polymerization conditions to form a poly(phenylmethyl)siloxane of Formula 1: Formula 1 wherein the cyclic phenylmethylsiloxane is represented by the formula: where R, x, and n are as defined herein. The method of the present invention provides a simple and inexpensive way to produce a key intermediate for the preparation of poly(phenylmethyl)siloxane containing compositions.

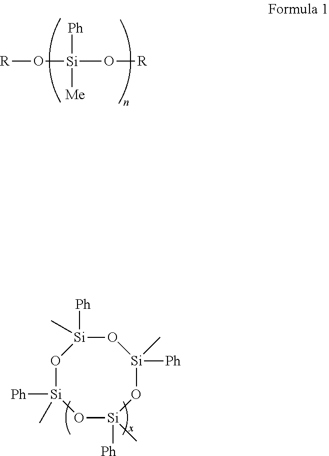

### BACKGROUND OF THE INVENTION

The present invention relates to a method for making an alkoxy- or hydroxy-terminated poly(phenylmethyl) siloxane, which is useful as a precursor to curable silicone-based compositions.

Curable silicone-based compositions are widely used as coatings and films that exhibit outstanding weatherability, inflammability, and high temperature stability. Earlier generations of these polymers were designed to be stable against degradation up to 200° C. for long-term use; recently, however, emerging industries such as power electronics and electric vehicles require protective coatings that are stable at temperatures generally in the range of from 250° C. to 300° C. for thousands of hours. Consequently, there existed a considerable gap between state-of-the-art commercial product offerings and the demands of high temperature-resistant applications.

It has recently been discovered that the required high-temperature stability could be achieved by using hydroxyl- or alkoxyl-terminated poly(phenylmethyl)siloxanes as a key intermediate in the preparation of the curable polyorganosiloxanes. This intermediate has superior thermal stability compared with hydroxyl- or alkoxyl-terminated polydimethylsiloxane due to the increased oxidative stability of the Si-phenyl bond versus the Si-methyl bond.

Hydroxyl-terminated poly(phenylmethyl)siloxanes with a degree of polymerization (DP) in the range of from 30 to 300 can be prepared by condensing a hydroxyl-terminated poly(phenylmethyl)siloxane oligomer with a degree of polymerization in the range of ~4 to 9; in turn, the oligomer can be prepared by the hydrolysis of dichlorophenylmethylsilane (PhMeSiCl₂). However, the intrinsic presence of residual monochlorinated phenylmethylsilanes in PhMeSiCl₂ leads to the formation of condensation byproducts with only one or no hydroxyl terminal groups. Therefore, high purity PhMeSiCl₂ containing <650 ppm of the monochlorinated impurities is required for making the high DP hydroxyl-terminated poly(phenylmethyl)siloxane intermediate. Unfortunately, the supply of high purity PhMeSiCl₂ is limited and very expensive, thereby severely hindering the practical use of the desired intermediate. There is even a greater need to find a simple way to synthesize alkoxyl-terminated poly(phenylmethyl)siloxanes, which arise from the alkoxylation of hydroxyl-terminated polymer precursors.

### SUMMARY OF THE INVENTION

The present invention addresses a need in the art by providing a method comprising the step of contacting a cyclic phenylmethylsiloxane with a chain transfer agent and a catalytic amount of a base under ring-opening polymerization conditions to form a poly(phenylmethyl)siloxane of Formula 1:

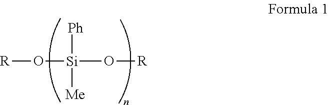

where n is from 10 to 800; and each R is independently H or C₁-C₁₂-alkyl; wherein the cyclic phenylmethylsiloxane is represented by the formula:

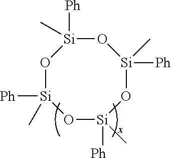

where x is in the range of from 0 to 5; and the chain transfer agent is represented by the formula R—OH, where R is H or C₁-C₆-alkyl or a combination thereof; and wherein the mole-to-mole ratio of the PhMeSiO repeat units of the cyclic phenylmethylsiloxane to the chain transfer agent is in the range of from 5:1 to 400:1. The method of the present invention provides a simple and inexpensive way to produce a key intermediate for the preparation of poly(phenylmethyl)siloxane containing compositions.

### DETAILED DESCRIPTION OF THE INVENTION

The present invention is a method comprising the step of contacting a cyclic phenylmethylsiloxane with a chain transfer agent and a catalytic amount of a base under ring-opening polymerization conditions to form a poly(phenylmethyl)siloxane of Formula 1:

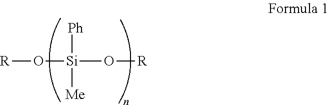

where n is from 10 to 800; and each R is independently H or C₁-C₁₂-alkyl; wherein the cyclic phenylmethylsiloxane is represented by the formula:

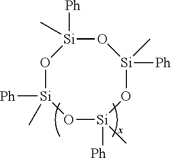

where x is in the range of from 0 to 5; and the chain transfer agent is represented by the formula R—OH, where R is H or C₁-C₁₂-alkyl or a combination thereof; and wherein the mole-to-mole ratio of the PhMeSiO repeat units of the cyclic phenylmethylsiloxane to the chain transfer agent is in the range of from 5:1 to 400:1.

Preferably, R is C₁-C₆-alkyl. Examples of suitable R groups include methyl, ethyl, propyl, isopropyl, n-butyl, t-butyl, n-pentyl, and n-hexyl.

The cyclic phenylmethylsiloxane can be obtained commercially (CAS 546-45-2) as a mixture with x predominantly in the range of from 0 to 2, with a prevalence of x=1.

The degree of polymerization of the poly(phenylmethyl)siloxane can be tuned by varying the mole-to-mole ratio of the phenylmethylsilyloxy (PhMeSiO) repeat units of the cyclic phenylmethylsiloxane to the chain transfer agent. For example, where x=1 (i.e., a cyclic phenylmethylsiloxane having 4 PhMeSiO repeat units), 2 moles of the cyclic phenylmethylsiloxane mixed with 1 mole of the chain transfer agent has mole-to-mole ratio of 8:1. The mole-to-mole ratio of the PhMeSiO repeat units to the chain transfer agent is in the range of from 5:1 or from 10:1 or from 30:1 or from 50:1, to 400:1 or to 300:1 or to 150:1 or to 100:1. Examples of suitable bases include alkali metal hydroxides such as LiOH, NaOH, KOH, and CsOH; as well as alkaline earth metal hydroxides such as Ca(OH)₂, Mg(OH)₂.

As used herein, “ring opening polymerization conditions” are conditions sufficient to cause the transformation of the cyclic phenylmethylsiloxane to the final product. In general, the reaction is carried out at a temperature in the range of from 50° C., or from 70° C. or from 90° C., to 150° C. or to 120° C. or to 110° C. The reaction time is typically in the range of from 0.5 hour to 120 hours.

When the chain transfer agent is water, the reaction is advantageously carried out in the presence of a polar aprotic solvent. Examples of suitable polar aprotic solvents include acetonitrile, acetone, propylene glycol, propylene glycol methyl ether acetate, 1,4-dioxane, dimethoxyethane, dimethylsulfoxide, dimethylformamide, 2-butanone, methyl isobutyl ketone, 2-pentanone, 2-hexanone, ethyl acetate, butyl acetate, and pyridine.

Coincidentally, the cyclic phenylmethylsiloxane starting material used in the present method is an unwanted byproduct in the process of preparing hydroxyl-terminated poly(phenylmethyl)siloxanes by the condensation process described hereinabove; thus, in the present method, unreacted cyclic phenylmethylsiloxane is recycled and reused; in the prior art method, it is discarded.

### EXAMPLES

### Viscosity Measurements

Solution viscosity was measured using a Brookfield cone & plate Digital Rheometer (cone/plate model #DV-III) at 25° C.

### NMR Spectroscopic Analysis

Nuclear Magnetic Spectroscopic measurements were obtained using a Varian EX-400 MHz Mercury spectrometer with CDCl₃ as a solvent. Chemical shifts for 13C-NMR spectra, and ²⁹Si-NMR spectra were referenced to the internal solvent resonance and reported relative to tetramethylsilane. The degree of polymerization (DP) for the dialkoxy-terminated PhMe fluid was calculated based the integration of the corresponding peaks in ²⁹Si-NMR (end group analysis). The percent yields were determined by dividing the integrated Si-methyl and Si-phenyl group resonances associated with the product polymer by the total integrated resonances in the spectrum. The percent of unreacted cyclic starting material was determined similarly.

### Example 1—Preparation of a Dimethoxy-terminated Poly(phenylmethylsiloxane) (DP=118)

Cyclic phenylmethylsiloxane (20 g, CAS 546-45-2), methanol (0.47 g), and KOH (100 ppm) were added to a 50-mL flask equipped with a stir bar, a heating mantle, and a condenser. The mixture was stirred and heated to 80° C. A small aliquot was taken out periodically for the viscosity measurement and NMR spectroscopic analysis. After 100 h, the viscosity of the solution was measured to be 26,220 cP. The reaction mixture was found to contain 91.2% of the dimethoxy-terminated poly(phenylmethylsiloxane) (DP=118) and 8.8 mole % of unreacted PhMe cyclics. The mixture was cooled to room temperature and neutralized with phosphoric acid. The unreacted starting material was removed in vacuo at 300° C. to yield the purified product.

### Example 2—Preparation of a Diethoxy-terminated Poly(phenylmethylsiloxane) (DP=196)

The procedure described for Example 1 was repeated except that ethanol (0.68 g) was used in place of methanol: 91.1 mole % yield, 8.9 mole % unreacted PhMe cyclics, final solution viscosity=31,085 cP.

### Example 3—Preparation of a Di-n-propoxy-terminated Poly(phenylmethylsiloxane) (DP=71)

The procedure described for Example 1 was repeated except that n-propanol (0.88 g) was used in place of methanol, and the mixture was heated to 110° C. for 64 h: 91.6 mole % yield, 8.4 mole % unreacted PhMe cyclics, final solution viscosity=7,338 cP.

### Example 4—Preparation of a Di-n-butoxy-terminated Poly(phenylmethylsiloxane) (DP=76)

The procedure described for Example 3 was repeated except that n-butanol (0.88 g) was used in place of n-propanol: 90.4 mole % yield, 9.6 mole % unreacted PhMe cyclics, final solution viscosity=6,318 cP.

### Example 5-Preparation of a Di-hydroxy-terminated Poly(phenylmethylsiloxane) (DP=78)

Cyclic phenylmethylsiloxane (15 g, CAS 546-45-2), water (0.20 g), acetonitrile (5.0 g), and KOH (100 ppm) were added to a 50-mL flask equipped with a stir bar, a heating mantle, and a condenser. The mixture was stirred and heated to 80° C. A small aliquot was taken out periodically for the viscosity measurement and NMR spectroscopic analysis. After 15 h, the viscosity of the solution was measured to be 560 cP. The reaction mixture was found to contain 82.1% of the dihydroxy-terminated poly(phenylmethylsiloxane) (DP=78) and 17.9 mole % of unreacted PhMe cyclics. The mixture was cooled to room temperature and neutralized with phosphoric acid. The unreacted starting material was removed in vacuo at 300° C. to yield the purified product.

### Comparative Example 1. Reaction of Dimethyl Cyclic D₄ (Me₂SiO)₄ with Ethanol in the Presence of Potassium Hydroxide

Cyclic dimethylsiloxane D₄ (20 g), ethanol (0.47 g), and KOH (100 ppm) were added to a 50-mL flask equipped with a stir bar, a heating mantle, and a condenser. The mixture was stirred and heated to 80° C. A small aliquot was taken out periodically for the viscosity measurement and NMR spectroscopic analysis. After 100 h the solution had a viscosity of 2.0 cP and contained 98.5 mole % unreacted dimethyl cyclic (D4:98.0%+D5-8:0.5%) and a small amount (1.5%) of diethoxy-terminated dimethylsiloxane oligomer (DP=2 to 3). No higher DP of diethoxy-terminated poly(dimethylsiloxane) was formed.

As Comparative Example 1 demonstrates, the method of the present invention is surprisingly ineffective for preparing dihydroxy- or dialkoxy-terminated polydimethylsiloxanes.

1. A method comprising the step of contacting a cyclic phenylmethylsiloxane with a chain transfer agent and a catalytic amount of a base under ring-opening polymerization conditions to form a poly(phenylmethyl)siloxane of Formula 1: 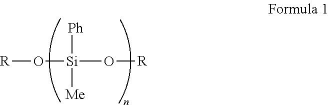
where n is from 10 to 800; and each R is independently H or C₁-C₁₂-alkyl; wherein the cyclic phenylmethylsiloxane is represented by the formula: 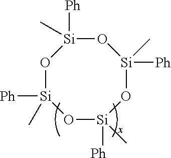
where x is in the range of from 0 to 5; and the chain transfer agent is represented by the formula R—OH, where R is H or C₁-C₆-alkyl or a combination thereof; and wherein the mole-to-mole ratio of the PhMeSiO repeat units of the cyclic phenylmethylsiloxane to the chain transfer agent is in the range of from 5:1 to 400:1.

2. The method of claim 1 wherein each R is H.

3. The method of claim 1 wherein each R is C₁-C₆-alkyl.

4. The method of claim 1 wherein each R is methyl, ethyl, n-propyl, isopropyl, n-butyl, isobutyl, or t-butyl.
